(19) United States
(12) Patent Application Publication
(10) Pub. No.: US 2014/0157324 A1
(43) Pub. Date: Jun. 5, 2014

(54) Content Identification and Management

(71) Applicant: COMCAST CABLE COMMUNICATIONS, LLC, Philadelphia, PA (US)

(72) Inventors: Weidong Mao, West Windsor, NJ (US); Mark Swan, Chester Springs, PA (US); Sree Kotay, Philadelphia, PA (US); Mark Vickers, Marina Del Ray, CA (US)

(73) Assignee: COMCAST CABLE COMMUNICATIONS, LLC, Philadelphia, PA (US)

(21) Appl. No.: 13/690,490

(22) Filed: Nov. 30, 2012

(51) Int. Cl. H04N 21/27; G06F 17/30

(52) U.S. Cl. CPC H04N 21/27; G06F 17/30023
USPC 725/54; 707/769

(57) ABSTRACT

Methods and systems are presented for managing allocation of names in a limited namespace for a pool of content objects or items. For each content object in the pool, one or more records are maintained that include mappings of different names from different name spaces.

### FIELD

Aspects of the disclosure relate to identifying content for access or delivery over a data network. Some aspects relate to providing content identifier mappings between different systems or networks.

### BACKGROUND

Network architectures for delivering digital media such as video programs, streaming audio, etc. to user devices may be composed of a number of different systems, such as content servers, storage repositories, delivery networks, schedulers, etc. One example of such a system may be an operator that provides a number of different services, such as linear programming, video-on-demand, network digital video recording, Internet access, etc., through a cable, optical, and/or wireless network. Several problems arise as different systems in the network architecture are upgraded and as the amount of content grows rapidly compared to network.

An example problem that may occur is that the different subsystems may have different naming conventions for the digital media, which may be limited in one or more aspects. For example, a legacy system may have a limited namespace from which to identify every item of content, e.g., a video, available to a user device through the system. These and other problems are addressed in the disclosure.

### BRIEF SUMMARY

This Summary is provided to introduce a selection of concepts in a simplified form that are further described below in the Detailed Description. This Summary is not intended to identify key or essential features.

The problem in attempting to identify and provide the vast number of available content items or objects to devices or users through an architecture that has limited naming capabilities is addressed herein. In one aspect, a solution is provided through the use of one or more computing devices, such as a content name server that shares limited namespace among a larger universe of available content objects.

Various embodiments include one or more computing devices, such as the content name server, that maintains records for a pool of content objects such as video programs. Each record may include one or more entries that map different names from different name spaces, e.g., of different subsystems, to the same content object or item. In some embodiments, the one or more computing devices (e.g., content name server) may respond to queries from different systems within a network architecture to translate names from one namespace to another namespace.

In certain embodiments, the records may be dynamically reallocated to share limited naming resources within the network architecture with a larger pool of available content objects for delivery to users or clients, e.g., client devices.

In some embodiments, different names in different namespaces for a content object are assigned by the various systems and registered with the content name server. In other embodiments, a name for a content object may be derived by each system based on commonly available metadata associated with a content object. In one example, subsystems may derive the same name for a video program based on metadata (e.g., program title, start time, format, channel, etc.) available through a third party electronic program guide.

Embodiments also include apparatus, systems, methods, and computer readable memory storing machine executable instructions for performing the functions of the embodiments described above, and further described below.

### BRIEF DESCRIPTION OF THE DRAWINGS

Some embodiments are illustrated by way of example, and not by way of limitation, in the figures of the accompanying drawings and in which like reference numerals refer to similar elements. For convenience, the first portion of each reference numeral corresponds to the drawing figure in which the referenced drawing element is first introduced.

FIG. 1 illustrates an example architecture in accordance with one or more embodiments of the disclosure.

FIG. 2 illustrates an example process for delivering content in accordance with one or more embodiments of the disclosure.

FIGS. 3A and 3B illustrate mappings between different namespaces in accordance with one or more embodiments of the disclosure.

FIGS. 4A, 4B, and 4C illustrate example records in accordance with one or more embodiments of the disclosure.

FIG. 5 illustrates an example process for reallocation of names in accordance with one or more embodiments of the disclosure.

FIG. 6 illustrates a partial schematic block diagram of a computing platform in accordance with one or more embodiments of the disclosure.

### DETAILED DESCRIPTION

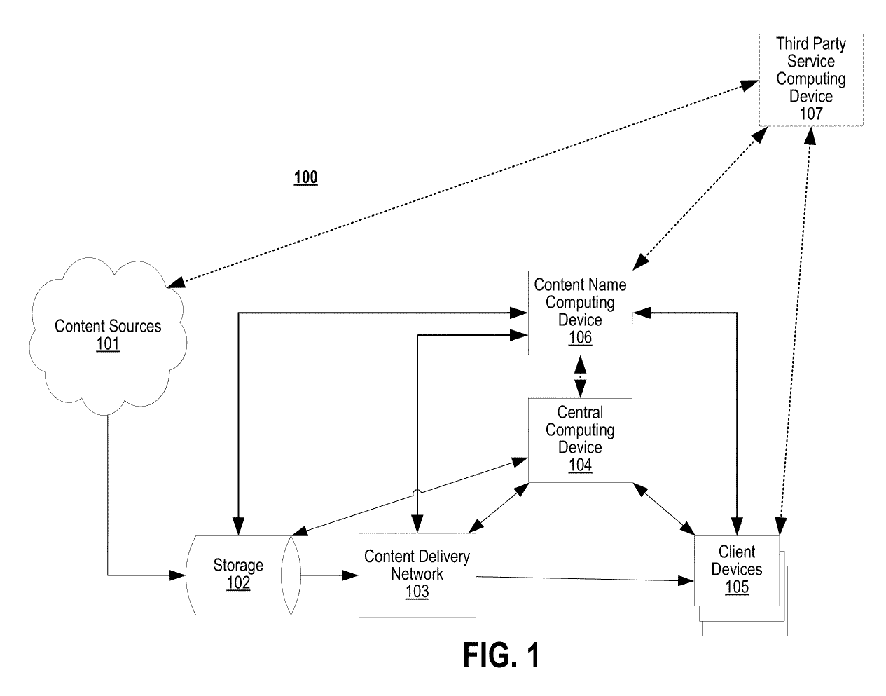

FIG. 1 illustrates an example architecture 100 of a data network (e.g., data delivery system) for providing content objects from multiple content sources 101 to multiple users or devices 105, e.g., client devices. In various examples, data network 100 may include multiple different portions that may be parts of a broadcast network, a video-on-demand network, television cable network, or other network that may provide content, such as multi-media data, to devices 105. In other examples, architecture 100 may be part of a data archiving or processing center such as an image/video repository, electronic document repository, map repository, etc. In another example, architecture 100 may be a fulfillment center or on-line store for providing electronic content, e.g., books, videos games, software etc., purchased or leased over a network. Architecture 100 may be, for example, in a single facility, such as a library or research institution, or may be distributed, such as across multiple servers across multiple different networks (e.g., cloud computing).

Examples of content objects may include multiple different types of data such as video, audio, image, text (e.g., electronic books and magazines), software, video games, and any other data set encoded or organized in a way to convey information.

Content sources 101 may include, in various examples, both linear content sources and non-linear content sources. Linear content sources may provide content on a predetermined schedule and may include, but are not limited to, a broadcast network (e.g., NBC, ESPN), a content aggregator such as a cable company, a radio station, etc. Non-linear content sources may provide content on a dynamic schedule, where a user may request and control the timing, and in some examples, the manner in which the content is delivered. Examples of non-linear content sources include, but are not limited to, video-on-demand servers, pay-per-view servers, data archives, web servers providing data over the Internet/World Wide Web, etc.

Devices 105 may include, in various examples, any number of electronic devices capable of receiving content objects and processing the objects in electronic form. Such devices may include network nodes, routers, user devices, personal computers, mobile computers, tablet computers, e-book readers, cellular phones, personal digital assistants, set top boxes, televisions, digital terminal adaptors, embedded multimedia terminals, cable modems, and other end devices.

Content delivery network 103 (e.g., a content delivery network or media delivery network) may employ any number of transmission techniques over different physical media, including, for example, hybrid fiber-coaxial cable transmission, coaxial-cable only transmission, fiber-optic only transmission, satellite transmission, cellular wireless transmission, RF broadcast transmission, POTS transmission, DSL transmission, power line transmission, etc., and/or combinations thereof to communicate information between storage 102 and the devices 105.

Content delivery network 103 may also include a number of different protocol formats, including, for example, a quadrature amplitude modulation (QAM) protocol and/or an Internet Protocol (IP) type network. QAM type networks may include, for example, a digital cable type network in which a digital encoded data stream, such as an MPEG-2 encoded transport stream, is modulated over a fixed frequency width QAM channel (e.g., 256-QAM 6 MHz channel). Using a QAM protocol network, a content object such as a video program may be, for example, encoded into an MPEG-2 video stream and transmitted as a sub-channel over one of the 6 MHz QAM channels.

IP type networks may include, for example, a network in which content objects are delivered over a packet switched network using the Internet Protocol suite. One such example is an Internet Protocol television (IPTV) network.

In various examples, content delivery network 103 may include a combination of different protocol formats, such as QAM protocol and IPTV protocol networks for delivering content objects from linear and/or non-linear content sources.

Storage 102 may include one or more data servers including data storage devices, such as magnetic tape, magnetic discs (e.g., a fixed hard disk drive or a removable floppy disk), optical disk (e.g., a CD-ROM disc, a CD-RW disc, a DVD disc, etc.), flash memory, memory, etc.

In architecture 100, devices 105 may request content objects from a computing device 104, e.g., a central server. The computing device 104 in turn may cause, through commands or requests, storage system 102 to retrieve and buffer the requested content objects from content sources 101. The central server may also cause, through commands or requests, content delivery network 103 to allocate transmission resources (e.g., bandwidth, transport streams, etc.) to provide the content objects from storage system 102 to the device 105 requesting the information.

In some variations, storage system 102 and/or content delivery network 103 may transcode the content objects received from the content sources to a format compatible with storage system 102, content delivery network 103, and/or devices 105. Transcoding the content objects may include partially or completely decompressing and/or decoding a content object received from content sources 101 and partially or completely re-encoding and/or re-compressing the decoded/decompressed content object in another format. For example, the content object from content sources 101 may be a video encoded in a format compatible for streaming over the Internet (e.g., wmv format, divx, quicktime format, etc.) that is transcoded to a format compatible for transmission through a QAM type content delivery network 103 (e.g., MPEG-2 over 256 QAM).

One example of a data network 100 is a video-on-demand system, where computing device 104 may include a video server back office, scheduler, and other systems; content delivery network 103 may include a combination of satellite, cellular broadcast, optical fiber, coaxial cable networks, etc.; and the devices 105 may include a number of set top boxes, digital terminal adaptors, personal computers, mobile devices and other equipment configured for receiving and viewing videos.

In various embodiments, the devices 105, computing device 104, content delivery network 103, and storage 102 may each have different requirements and capabilities for handling metadata that identifies each of the content objects. For example, some QAM type networks such as a cable company network, a video back office in computing device 104 may use a provider ID and asset ID (PAID) type naming convention, while a content source (e.g., web server, data archive) may use an Internet mapped Universal Resource Locator (URL).

In a PAID namespace, the provider ID may denote the source address for the content object (e.g., server1.com in storage 102), and the asset ID may be fixed length (e.g., 8 bytes) value for uniquely identifying the content object. An example PAID naming convention is further described below. In such a naming convention, the number of potential identifiers (i.e., the namespace) is limited by the fixed length PAID value. This limited namespace may restrict the number of content objects that can be scheduled for delivery to devices (e.g., devices 105). The number of content objects that can be scheduled for delivery may also be limited by other factors, such as the capacity (e.g., storage capacity, processing capability/speed, data throughput, etc.) of the systems in the data network 100 (e.g., central server, video back-office, etc.).

While the delivery system may be limited in the number content objects that can be scheduled for delivery, the number of possible content objects that may be requested by the devices 105 may be more numerous. For example, a device 105 may have multiple sources from which to choose content. These sources may include, for example, an electronic program guide that lists linear programming from a number of providers according to a transmission schedule, a video-on-demand catalog that lists a number of archived video programs, audio programs, etc., an online store catalog that lists available music, e-books, magazines, software, etc., a game server catalog that lists a number of video games, an Internet search engine that provides a list of web content available based on search terms, etc. In some variations, devices 105 may discover content objects through a third party service computing device (e.g., server) 107 that may provide any of the above sources independent of the data network 100.

A problem arises in attempting to identify and provide the vast number of available content objects to devices 105 through an architecture that has one or more portions (e.g., subsystems) with a limited namespace. In view of this namespace limitation, various embodiments as disclosed herein address this problem for the first time, through use of a content name computing device (e.g., server) (CNCD) that shares the limited namespace among a larger universe of available content objects. FIG. 1 illustrates one example of a content name computing device (CNCD) 106, which in various embodiments may be a content name server or a media name server.

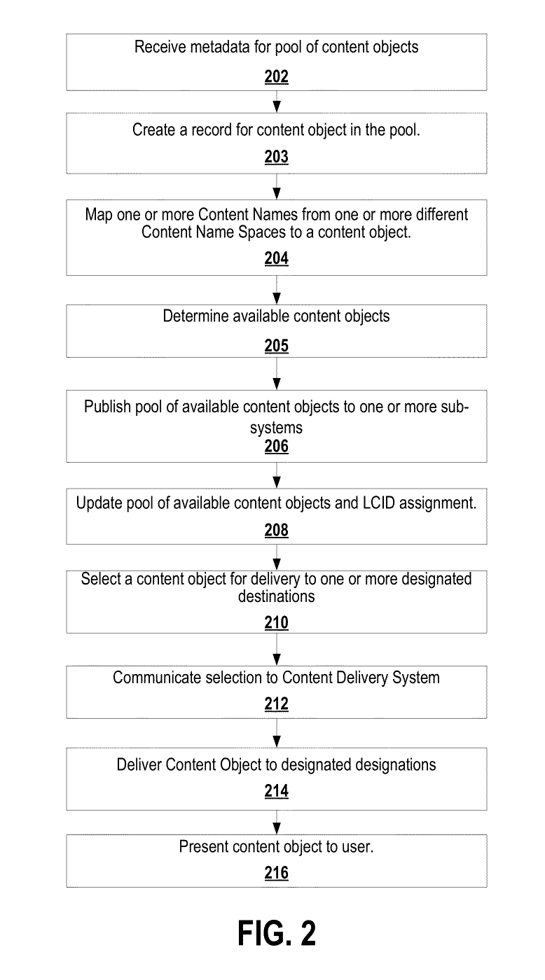

FIG. 2 illustrates one example of a process for delivering content objects to users or devices (e.g., devices 105) through data network 100, using a computing device such as CNCD 106. The process begins at step 202, where a computing device (e.g., CNCD 106) receives metadata that identifies a pool of content objects available for delivery through data network 100 to devices 105.

Certain variations of the data network 100 may receive the metadata in step 202 in different and/or multiple ways. For example, in one variation, data network 100 may be part of a video on demand system serving a finite set of content objects that the service provider had determined to make available to one or more user devices. In such a situation, the content objects (e.g., videos, games, etc.) may be pre-stored in storage 102, and the metadata identifying the content objects may include file names, URLs and/or other identifiers in a namespace used by storage 102 to identify the content objects. In another variation, the metadata may include a filename, URL, or other identifier in a namespace used by content sources 101. In some variations, the metadata may include one or more other content object descriptors enabling the retrieval of the content object. Such descriptors may include, for example, a program name (e.g., “Saturday Night Live”), season, episode, episode title, program/episode description, one or more broadcast dates, one or more broadcast times, network (e.g., NBC), channel, geographical broadcast regions, file formats, aspect ratio, resolution (e.g., standard definition, high definition, 730p, 1080i, etc.), encoding, scheduling code (VCR Plus+, G-Code, VideoPlus+, ShowView, etc.), etc. Such data may be found and used, for example, in a listing service, such as an electronic program guide.

In another example, data network 100 may include an online e-book store, in which the metadata may include a catalog of book titles, publishers, International Standard Book Number (ISBN), etc.

In step 203, for one or more of the content object in the pool of content objects, a computing device (e.g., CNCD 106) may optionally store and maintain a record having one or more entries of metadata associated with the content object. The records may be maintained in a database or other data format. In various examples, a set of records for the pool of content objects may be configured as a static data set that does not change over time, or as a list that is iteratively and/or periodically updated. The updates may include adding entirely new records of content objects and/or adding/modifying metadata for already existing records.

In some variations, the computing device (e.g., CNCD 106) may create a Local Content Identifier (LCID) space for the pool of content objects. The LCID space may be the same as one of the subsystem namespaces, or may be a unique namespace. The LCID space may be used in various aspects of data network 100. For example, the LCID space may be used by the computing device (e.g., CNCD 106) internally for organizing and managing the records. In another aspect, the LCID space may be used to refer to content objects in communications between subsystems of the data network 100 as further described below.

Each of storage 102 (e.g., back-end servers), content delivery network 103 (e.g., cellular network, HFC network, etc.), computing device 104 (e.g., central server, VOD back office, ISP, etc.), device 105 (e.g., set-top box, cellular phone, computer, etc.) and/or other systems within the data delivery system 101 may use an LCID to reference a content object or may use a name/identifier in its own namespace to identify the content object.

In various examples, in step 204, the computing device (e.g., CNCD 106) maps in each record the content object to one or more different content identifiers from different namespaces used by the subsystems in the data network 100. For example, content source 101, storage 102, CDN 103, computing device 104, and/or devices 105 may each use one or more different identifiers in different namespaces to refer to the same content object. The record for that content object associates these different identifiers together, along with the other metadata stored in the record.

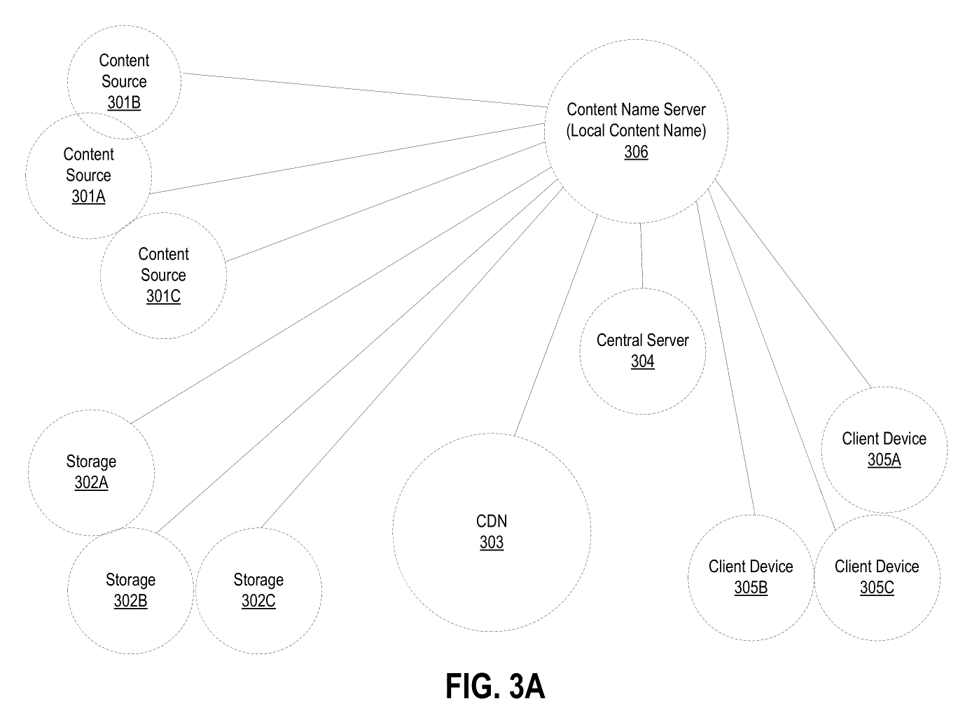

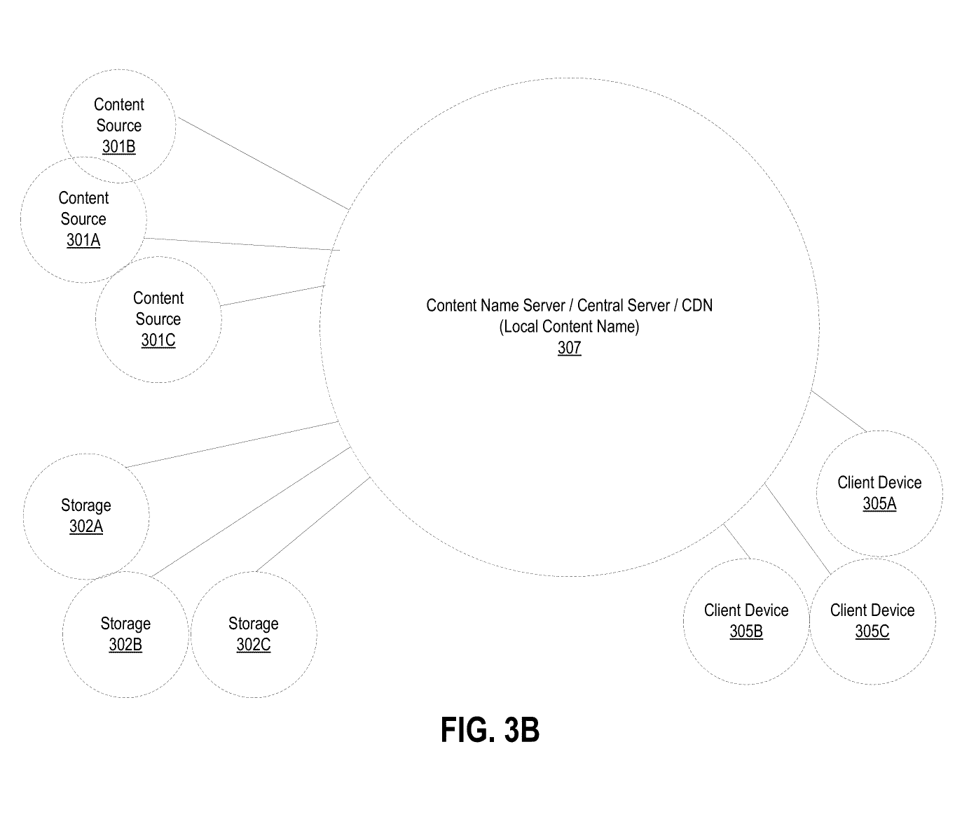

FIG. 3A illustrates a Venn diagram representing the mappings (illustrated as solid lines) between different namespaces (illustrated as dashed circles) within data network 100. Content Sources 101 may include one or more namespaces, e.g., 301A-C, each namespace including a different number of content object identifiers and each namespace including separate and/or shared sets of identifiers. A single content source may include multiple namespaces, e.g., a namespace for standard definition content and a namespace for high definition content. In various examples, in namespaces that share a common set of identifiers (e.g., 301A and 301B), a common identifier may refer to the same content object in each namespace, or may refer to different content objects in each namespace.

In the example of FIG. 3A, three storage namespaces 302A-302C are illustrated, although more or less namespaces may be included. Each namespace may be used, for example, by three different content servers (e.g., video on demand servers). The CDN 103 and computing device (e.g., central server) 104 may each have unique namespaces, 303 and 304 respectively. Devices 105, or sets of devices, may also have separate namespaces, e.g., 305A-305C. The different namespaces may be utilized, for example, by different types of devices (e.g., set top boxes, cellular phone devices, personal computers, etc.). As another example, a device 105 may customize its own namespace based on user preferences.

Using the records for the pool of content objects, a computing device (e.g., CNCD 106) may associate one or more identifiers in each different names space to each other and/or to an LCID in LCID space 306. In certain variations, the records may include metadata that identifies uniquely each different namespace. Content objects having an identifier that is common between two different namespaces (e.g., 301A and 301B) may be uniquely identified by the identifier and the metadata identifying the namespace.

In other variations, namespaces of different subsystems may be the same. FIG. 3B illustrates one such example in which the LCID space 307 in the CNCD 106 is the same as the namespace for computing device (e.g., central server) 104 and CDN 103.

Content identifiers in the different namespaces may be assigned in various ways. In some variations, a subsystem (e.g., storage 102) may determine/assign one or more identifiers for a particular content object from that subsystem's own namespace. The subsystem may then provide the assigned identifier(s) to the CNCD 106, via a broadcast message, query, etc., for inclusion in the content object record. In other variations, the CNCD 106 may assign the identifiers for a particular subsystem's namespace according to different algorithms and requirements for the namespace. If the CNCD 106 assigns the identifier of a content object in a namespace used by one of the subsystems, the CNCD 106 may provide, via a broadcast message, query, etc., the assigned identifier to the subsystem for later referral to the content object.

In some variations, LCID space is managed by the CNCD 106 such that the pool of content objects assigned LCNs is limited to within the overall capabilities of the data network 100. For example, storage 102, CDN 103, or one of the other subsystems may be bandwidth limited. For example, the limited subsystem may be able to refer to or deliver only a fixed number (e.g., 100) of high-definition video content streams and a fixed number (e.g., 110) standard definition streams simultaneously. In such a case, the CNCD may limit the number (e.g., 100) of LCNs to be allocated for high-definition content and the number (e.g., 110) of LCNs to be allocated for standard-definition content.

In some embodiments, the available LCID space may be divided so that different sources of content (e.g., different VOD servers in storage 102) may each be assigned a different unique range or set of LCNs. In other variations, portions of the LCID space may be allocated to different formats/encodings/types of content, etc. For example, as previously noted, the CNCD may limit the number of LCNs may be reserved for high definition video content, and another limited number of LCNs may be reserved for standard definition content. In another example, a limited number of LCNs may be reserved for MPEG encoded content and another limited number of LCNs assigned to H264 encoded content. In another example of an online e-book store, different limited numbers of LCNs may be assigned for fiction, non-fiction, textbook, audio-book, etc.

In some examples, the number of LCNs allocated for each type of content may be based on various factors (e.g., traffic, number/type of content request, time of day, content availability, etc.). In one variation, allocation of LCNs may be based on marketing considerations to promote some types of content over others, such as promoting recent releases of new videos, music, or books. In another variation, allocation of LCNs may be based on preferences and request history of devices 105. In further variations, allocation may be based on conditional access rights of one or more devices 105.

In certain variations, the different limits on the number of LCNs for each category of content may be stored in the CNCD or other subsystem. In certain variations, the stored limits may be static, or may be varied dynamically based on the capabilities of the system and/or based on the current usage (e.g., traffic, number/type of content request, time of day, content availability, etc.)

In step 205, a list of content objects in the pool of available content objects may be determined and stored, for example to a memory. In step 206, the determined list may then optionally be published to one or more of the subsystems. For example, the list of available content objects may be published to one or more of the devices 105. The published list may take, in some examples, the form of an electronic program guide or other interactive interface displayed on the user device.

In some variations, the published list may be tailored for each different subsystem that receives the list. For example, for a device that does not have the capability of processing high definition content objects, the published list to that particular device may include only standard definition content objects. In a similar fashion, the published list, in other variations, may be tailored based on any category, or combinations of categories of metadata (e.g., a program name, season, episode, episode title, program/episode description, one or more broadcast dates, one or more broadcast times, network, channel, geographical broadcast regions, file formats, aspect ratio, resolution, encoding, scheduling code, etc.). In another example, the pool of available content objects may be published to content object servers in storage 102. For each server, the published list may be tailored for each server to include only content objects to be stored in that respective server. In any of the examples where the published list may be tailored for a specific subsystem, the CNCD 106 or other computing device may tailor the list or the subsystem may tailor the list, for example, by receiving the entire list of content objects and then filtering the list by any criteria, such as by metadata categories.

In step 208, the pool of content objects may be updated to add, delete, or modify content object records, and to update the assignment of LCNs to the records. In one example, any of the subsystems may report new or updated content object information to the CNCD 106. For example, as sources 101 and/or storage 102 produce, acquire, and/or store new content objects, the sources/storage may send a message to the CNCD 106 to report the availability of the new content object. The CNCD 106, in various examples, may then assign an LCID to the new or updated content identifier and report the assigned LCID to the computing device 104 or other subsystems. In other variations, the LCID is assigned and reported back to the subsystem that originally reported the new object. The subsystem that originally reported the new object may then report the availability of the new object to other subsystems.

In step 210, a content object may be selected for delivery to one or more destinations (e.g., devices 105, client devices, user devices, nodes, etc.). Step 210 may be conducted in response to either a request by a device 105 for the content object, or in response to one of the other subsystems initiating a transfer of the content object. Step 210 may also be conducted periodically, or at scheduled predetermined times.

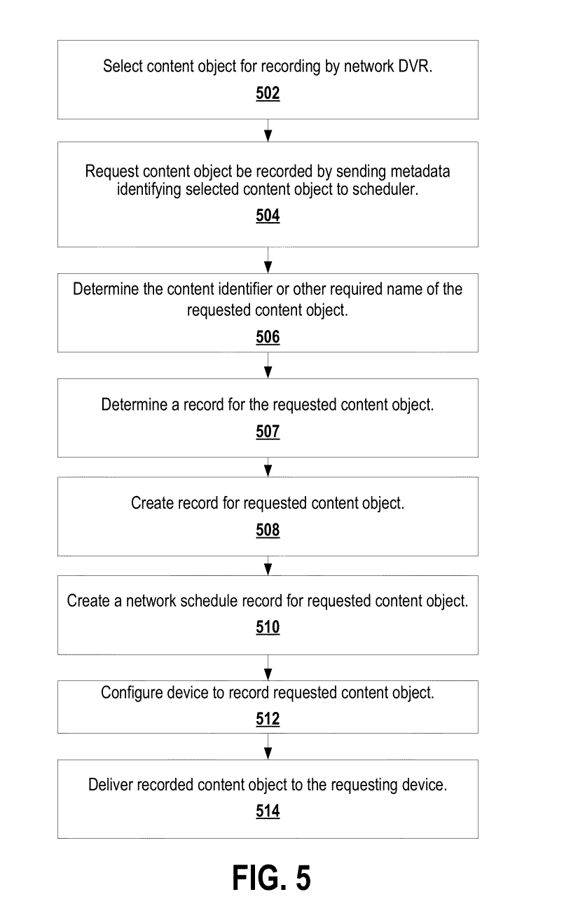

In one variation, computing device (e.g., central server) 104 may include a scheduler, that schedules content objects to be pushed to one or more devices 105 on a periodic basis or as new content objects become available for delivery. One example of scheduler used in data network 100 that includes a network DVR or other video delivery service is described below with respect to FIG. 5.

In certain variations, a device 105 may select the content object to receive. In one variation, the LCID, identifier of content object in the device 105 namespace, content object description, or any other information matching data in the content object's record is received by the device 105 as an input from a user input device (e.g., remote control, keyboard, etc.). In another variation, the LCID, identifier of content object in the device 105 namespace, content object description, or any other information matching data in the content object's record is received as a selection from the published list of content objects (e.g., from the CNCD 106). The published list may be presented in various forms (e.g., electronic program guide, scrolling overlay, etc.) on a display connected to the device 105. In yet another variation, the LCID, identifier in the device 105 namespace, description, or any other information associated with the content object may be selected from a third party content metadata service (e.g., third party program guide, electronic television listing, interactive menu, etc.). In another variation, information identifying the content object may be selected from information sent to the user device in response to a query by the user device to the sources 101, storage 102, CDN 103, computing device 104, CNCD 106, any other subsystem in the data network 100, or from a third party service, such as a search engine (e.g., Google®, Bing®, interactive set top box search application, etc.).

In one example, step 208 may be request-driven and performed after step 210, with content objects added to the pool as requests for delivery of the content objects to the requesting devices are generated. One benefit of request driven updating is apparent in the example of Internet content sources. Rather than attempt to ingest and catalog all video or other content available on the Internet to include in the pool of content objects, the system may await a device's or other subsystem's request in step 208 to deliver content. A device 105 may discover a desired content object available on the Internet (or other domain) through use of a search engine or other list. When a device 105, for example, receives a request from a user for a particular URL, the computing device 104 (e.g., central server) or other device in the data delivery system may have a server check (e.g., query) the URL for video content or other content usable by device 105. If the requested URL corresponds to a video file or other content object compatible with device 105, then the computing device 104 may pass the URL to the CNCD for adding a record for the content object to the pool of content objects and mapping an LCID to the content object.

In step 212, once the content object is selected for delivery, the selection may be communicated to one or more subsystems of the data network 100. In one example, a requesting subsystem (e.g., device 105) may communicate a request for delivery that includes information identifying the selected content object (e.g., URL, program name, broadcast channel, broadcast time) to one of the other subsystems (e.g., computing device 104). The communicated information may include any information from which the computing device 104 (e.g., central server) or other subsystem may identify the content object.

For example, the communicated information may include the identifier of the content object in a namespace that the computing device 104 (e.g., central server) can decode or process. In such an example, the device 105 may derive the identifier in the central server's namespace through one or more algorithms, or may query the CNCD 106 for the identifier by providing information that can be matched to information in the selected object record. In response to the query, the CNCD 106 may match information to the content object record, prepare a response that includes the LCID and/or other identifiers associated with the record, and transmit/provide the response to the requesting device for use in the content object request to another subsystem.

In another example, a subsystem (e.g., computing device 104) may receive a content object request that includes identifying information that is not directly decodable by the receiving subsystem. For example, a computing device 104 (e.g., central server) may receive from a device 105 a delivery request including the identifier of the content object in a namespace used by device 105. To determine what content object is requested for delivery, the computing device 104 may, using the provided information from the device 105, query the CNCD 106 for a content object identifier that is decodable by the computing device 104.

In another example, the CNCD 106 may act as a translator between subsystems. In such an example, the delivery request is sent to a translator computing device (e.g., CNCD 106) (e.g., from device 105), and the provided identifying information is resolved to a content object record. From the content object record, the CNCD 106 determines a content object identifier decodable by the receiving subsystem (e.g., computing device 104), and the CNCD 106 forwards the request to the receiving subsystem with the determined content object identifier.

In step 214, data network 100 may deliver the requested content object to the designated devices 105 or to another designated device in the subsystem. In various embodiments, this may involve several configuration steps and communications between subsystems. In one example, computing device 104 (e.g., central server) may receive the delivery request and then: 1) configure storage 102 to retrieve the requested content object from a content source 102, 2) configure CDN 103 to assign a communication channel and reserve bandwidth for delivering the content object, and 3) at a scheduled time for delivering the content object, initiate the CDN 103 to retrieve the content object from storage 102 and deliver the content object to the designated devices. In such an example, each step involves communications between the subsystems that identify the content object.

Each communication may use any identifying information by which the receiving subsystem may identify the content object, either directly, or via querying the CNCD 106. For example, each communication could include the LCID for the content object, and each subsystem can query the CNCD 106 for specific information required. For example, storage 102 may query the CNCD 106 for a URL of a content source from which to retrieve the content object. Similarly, CDN 103 may query the CNCD 106 for the identifier by which it can retrieve the content object from storage 102 (e.g., a URL, filename, etc., used by a server in the storage 102) and/or the identifier by which to deliver the content object to the requesting devices.

In some variations, once an identifier (e.g., URL) of a content object from a content source 101 is mapped to an LCID by the CNCD, the data delivery system may begin to ingest and transcode the content (e.g., video content) from the content source and store the content object in storage 102. From there, the computing device 104 or other device may use the assigned LCID to reference the content in storage 102 and allocate resources within content delivery network 103, and queue the delivery of the content to the device 105.

In step 216, device 105 may optionally present the content object on a display or as audio output (e.g., to a user). Various embodiments may include displaying the content object (e.g., image, video) to a viewer via a display and/or outputting sounds (e.g., music, audio tracks, etc.) via one or more speakers communicatively coupled to device 105. The content object may include other information that is presented by device 105 in the form of motion (e.g., vibrations, tilting, etc.), smells, or other interactive features via one or more transducers, machines, etc., for generating the interactive features.

In certain variations, data network 100 may not include a central server and/or the various subsystems may be combined into one system. For example, storage 102 and computing device 104 (e.g., central server) may be combined into a common system. In such variations, communications between subsystems, such as a request for a content object, may be between different subsystems from what is described above. For example, a device 105 may send a request for a content object directly to a content source 101, to storage 102, and/or to another subsystem (e.g., scheduler, resource manager, etc.) not shown. In each such scenario, the CNCD 106 may operate in principally the same way. That is, the CNCD 101 may receive queries that include information identifying a content object, and respond with an LCID or other identifier that may be used by the requesting device, or by another device to communicate the identity of the content object. In other variations, CNCD 106 may receive an LCID and return an identifier in a particular namespace associated with the LCID. In one example, the CDN 103 may receive an LCID in a request to configure the CDN 103 for delivery of a content object (e.g., step 212). Using the LCID, the CDN may then query the CNCD 106 for an identifier in the storage 102 namespace in order to request the content object from the storage.

In other variations, the CNCD 106 may operate as a translator, forwarding requests and other communications with identifying information translated into an LCID or other identifier used by the receiving device. In any of the examples, certain variations of CNCD 106 may select which identifier to return or translate based on the source of the incoming query/message and/or based on the destination of the response/translated message. For example, an incoming query may identify the namespace (e.g., storage device namespace 302A) for the identifier of the content object in the return/translated message.

In the process in FIG. 2, various embodiments may perform the steps in a variety of orders. In one example, the list of content objects may be published to devices 105 (e.g., step 206) and/or a content object is selected for delivery (e.g., step 210) before the mapping of the LCID to different namespaces (e.g., step 204). This might be the case, for example, where data network 100 is part of a multimedia service that includes a pool of content objects available from content sources 101 that is larger than the number of content objects that can be handled by the data network 100 at any one time. Another example may include a system where data network 100 is part of a linear program delivery system (e.g., cable company), where the entire pool of available content objects for a fixed duration into the future (e.g., two weeks) is known, updated periodically (e.g., every day), and listed in a catalog (e.g., electronic program guide) available to the devices 105 and subsystems.

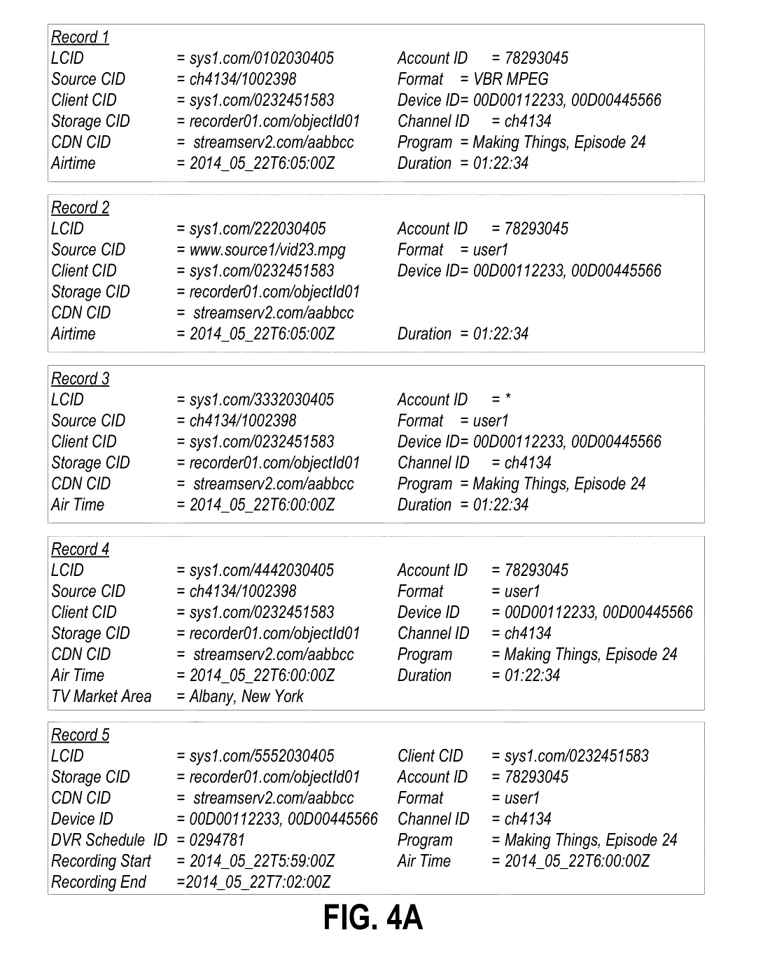

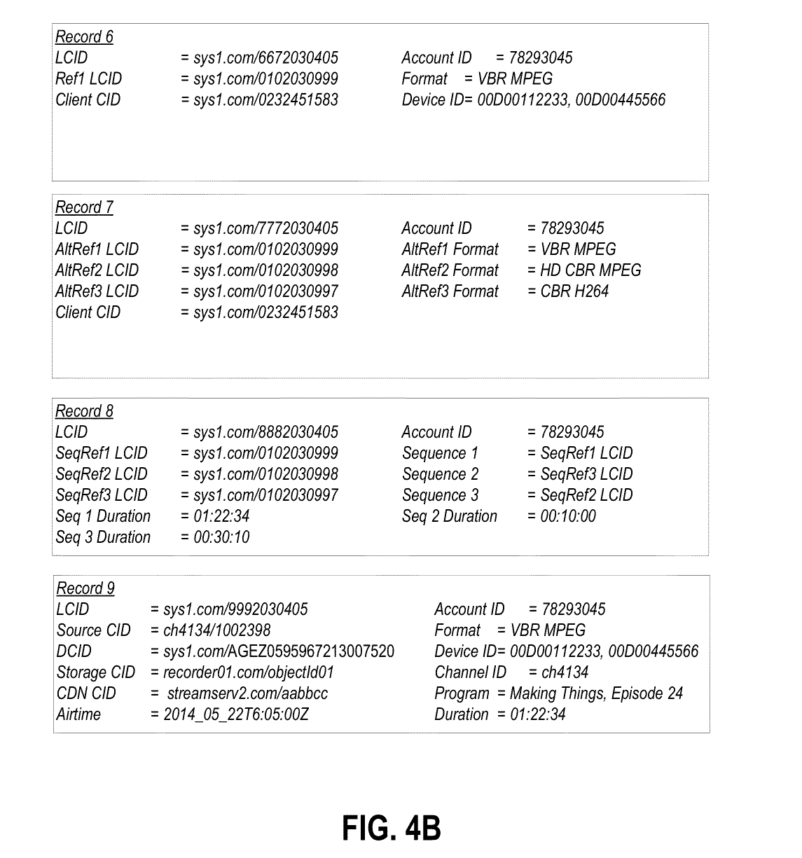

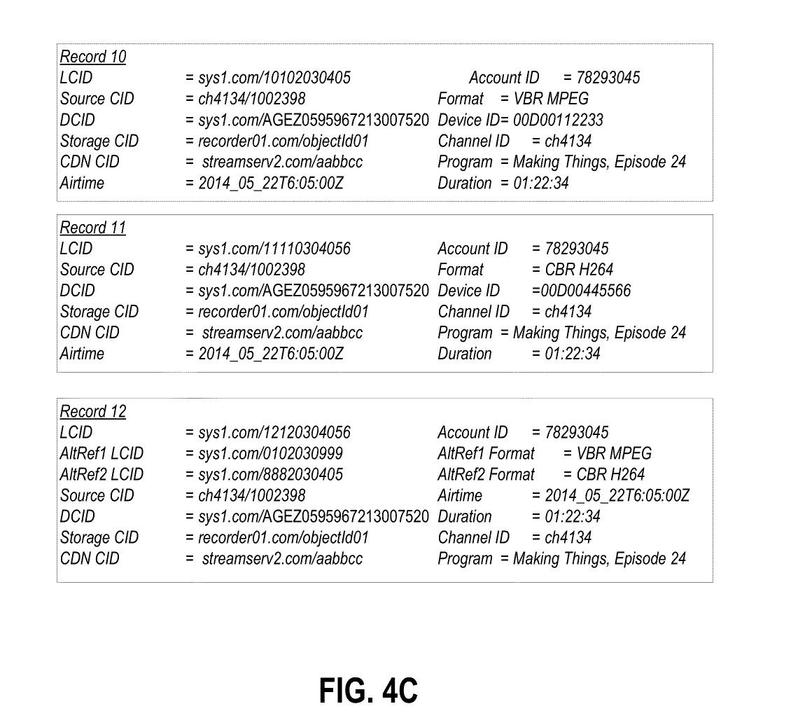

FIGS. 4A, 4B, and 4C illustrate various examples of records that may be maintained by CNCD 106 for a pool of content objects. The table format in FIG. 4 is organized for illustration only to show the associations between different data items maintained by the CNCD 106. Various embodiments may store the illustrated data items in any order or manner (e.g., spreadsheet, database, etc.) suitable to maintain the data items and the associations between the data items.

In various embodiments, each record in the pool of content object records may include different entries, each entry including an entry label and associated entry value. For example, FIG. 4A includes an example record 1 for a video program stored in a linear program delivery system. In record 1, the first listed entry label LCID denotes the local content identifier with an associated value of “sys1.com/0102030405.” The LCID value may include one or more parts. In this example, a first part, sys1.com, denotes the linear program delivery system, and a second part 0102030405 denotes a unique name in the local content namespace. Another entry label Source CID denotes the origin of the content. In this example, the content originates from channel 4134 in the linear program delivery system and has a unique identifier 1002398 that may identify the content in the source namespace (e.g. 303A). Client CID denotes an identifier in device 105 namespace and includes a value sys1.com/0232451583. The first part of the value, sys1.com, may denote the linear program delivery system to which the devices 105 connected, and the second part may denote a unique identifier for the content in the device 105 namespace. Another entry, Storage CID, includes an example entry value having a first portion that may denote a particular device in storage 102 among a plurality of storage devices. For example, storage 102 may include a number of content recorders (e.g., remote DVR), and recorder01.com may be a unique name for one of the content recorders. A second portion of the entry value, e.g., objectId01, may denote a unique name for the content in a namespace used by recorder01. An entry having a label CDN CID may denote the content delivery network 103 through which the content is delivered to the device 105, and the value streamserv2.com/aabbcc may be a unique name for the content in the content delivery network 103 namespace. In this example a first portion of the value, streamserv2.com, may denote a particular server within CDN 103 for streaming the content to the device 105, and a second portion of the value, aabbcc, may denote a unique name for the content in the CDN namespace. The unique name may be for the entire CDN, or may be unique just for the denoted streaming server.

In various embodiments, in each of the entries in the record as described above, the first parts of the associated values identify the associated subsystems, and may be used to resolve a location of the subsystems. For example, the Source CID above identifies the location as a channel (e.g., channel 4134). In various other embodiments, the source location could be an internet address which can be resolved to a website and/or server over the Internet and from which the content may be retrieved. Likewise, the storage CID may include a first part that may enable the system to resolve the location, on a local or global network, of the storage device storing the content. The first parts of the CIDs may all be in the same format (e.g., an IPv4 address, IPv6 address, URI), or may each be in a different format. For example, source CIDs for sources external to data network 100 may be in a format resolvable over the World Wide Web, while the storage CID may be in a locally addressable network format having a local scope just within the data network 100. By permitting the location format to be specific for each subsystem, embodiments may be used across multiple platforms having different addressing standards. Further, because the records may be updated, as further described below, location resolution of the content from subsystem-to-subsystem can be maintained as content is added, moved, or deleted.

Record 1 may include other entries, for example, that are associated with a unique user, customer, user account, and/or user device, etc. For example, the content associated with record 1 may be a unique copy of the content just for a particular user/account identified by the Account ID entry having a value 78293045. For example, the content associated with record 1 may be encrypted and/or protected with other conditional access techniques that permit only a device associated with the identified user account to decode and present the content. Another entry, Device ID, may identify one or more devices 105 on which the content may be decoded and displayed, e.g., devices 00D00112233 and 00D00445566. Other entries for example, may indicate delivery and/or playback requirements associated with the user account/device. In this example, the entry Format denotes that the devices associated with the user account require variable bit rate MPEG encoded content. In various examples, the data network 100 may transcode the content to the required format for playback.

Other entries in the record, for example, may provide metadata that enables the content to be captured from a source, e.g., program guide data for the linear program delivery system. For example a Channel ID having a value ch4134 may denote a particular television channel on which the content is to be broadcast, a Program entry having a value, Making Things, Episode 24, may denote a title for the content, airtime may denote a time at which the program will begin to be broadcast, and a Duration entry having a value 01:22:34 may denote the length of time which playback the content runs. The values may be in any one of numerous formats. In this example Airtime having a value 2014_{—}05_{—}22T6:05:00Z, denotes a broadcast time in the year 2014, in the fifth month of the year, on the 22nd day of the month, at the six hour, fifth minute, and 0 seconds. In various examples, Airtime and other entries denoting time maybe formatted, for example, according to Network Time Protocol (NTP) or other standard format. The airtime may be in the time zone in which one component (e.g., device 105) of data network 100 is located in, or may be indicated in the Airtime entry or other entry in the record. Further, in this example, the Duration entry may include a first portion of the entry (e.g., 01) denoting a number of hours, a second portion of the entry (e.g., 22) denoting a number of minutes, and a third portion of the entry (e.g., 34) denoting the number of seconds.

Record 2 is an example of a record for content retrieved from a web server source connected through a network (e.g., the Internet). Record 2 may include similar entries as record 1, except that the Source CID may denote a Web server. For example, the entry may have a first portion, www.source1, that denotes the Web server address, and a second portion, vid23.mpg, that denoting a filename used by the Web server. In various examples, the content may be available upon request from the Web server. In other various examples, the content may be scheduled to be streamed at a particular scheduled time. If the content is to be streamed at a particular scheduled time, the record may include entries denoting the start time and duration of the streaming of the content (e.g., Airtime, Duration).

In certain variation, the recorded content object (e.g., video program) is an individual copy of the program that is uniquely recorded for only the requesting device. For example, the content associated with records 1 and 2 may be unique to the account identified by the Account ID entry. In other variations, the recorded content object may be a common copy that is available to a number of devices 105 that share access to the content object. For example, the data network 100 may include a network DVR service and may include a single copy of a content object recorded form multiple different devices 105. In such variations, the common copy and the content object record and assigned LCID may persist in the CNCD 106 until all of the devices 105 have selected to delete the recorded program.

Record 3 is example of a record for content that may be shared by one or more devices 105 (e.g., common content). In this example, the entries are similar to those a record 1 except that the value of the Account ID entry may include a wildcard character (e.g. *) or other value denoting that the content is available for use by any device 105, or by a subset of one or more devices 105.

Record 4 illustrates another variation of a record similar to that of record one, but including other metadata. For example, record 4 may include an entry labeled TV Market Area having a value of Albany, N.Y., which indicates the broadcasting region from which the content is available.

Record 5 illustrates another variation of a record that may include information identifying a program to be recorded in a recording service, such as a network DVR service. In record 5, certain variations may include entries related to the DVR service. For example, an entry labeled DVR Schedule ID having a value of 0294781 may identify the record as a scheduled recording for a scheduler or other subsystem within data network 100. In various examples, other entries may include a Recording Start entry and a Recording End entry having values of 2014_{—}05_{—}22T5:59:00Z and 2014_{—}05_{—}22T7:02:00Z, respectively. The formats for the entries may be the same as the Airtime entry for may be of some other format. In this example, the recording service is scheduled to start at 5:59 AM and to stop at 7:02 AM. In certain variations, other parameters may be used with the DVR service. For example, in some variations, Airtime and Duration entries may be used to schedule the DVR service. Other variations of a record indicating a program to record may, for example, be the same as in record 1, and determine whether content is scheduled to be recorded based on whether the Airtime has passed or is at some time in the future.

Record 6 illustrates another variation in which the record refers to another record, such as a common content object record. For example, record 6 may include an entry labeled Ref1 LCID, which refers to another record having an LCID of sys1.com/010203099. Record six, for example, may indicate that an account having the indicated Account ID may access content associated with the referenced record, which may be associated with common content available to one or more user devices, accounts, etc.

Record 7 illustrates another variation where the record refers to multiple other records organized as alternative content objects. For example, record seven may include three entries, AltRef1 LCID, AltRef2 LCID, and AltRef3 LCID, which point to three alternate versions of the same content. Each version, for example, may be the same content encoded in different formats, the same content recorded from different broadcast regions, same content recorded in different resolutions, etc. In certain variations, for example, each alternate content object may have other record entries associated with it. For example, an entry labeled AltRef1 Format and having a value VBR MPEG may indicate that the content associated with the AltRef1 LCID entry is encoded with a variable bit rate MPEG 2 encoding. Similarly, entries labeled AltRef2 Format and AltRef3 Format may indicate that the content associated with the AltRef2 LCID and AltRef3 LCID entries are encoded with MPEG-2 encoding at a high definition resolution and an H264 encoding, respectively.

Record 8 illustrates another variation where the record refers to other multiple records organized as a compilation. In one variation, the compilation may be a playlist indicating a sequence, times (relative and/or absolute), and other metadata indicating the order or manner of retrieving, delivering, presenting the multiple references content objects. For example, record 8 may include entries for three different content items to be retrieved and presented in a sequence. The three different content items are identified by SeqRef1 LCID, SeqRef1 LCID, SeqRef1 LCID, respectively, which point to other content records as in record 6 and record 7. Although the example in record 8 may include references to other records, the sequence of content items may be identified directly as in the examples of records one through five. That is, for each referenced content, entries may be included that identify the referenced content by a name in the source, client, storage, CDN, or other namespace within data network 100.

Other entries in record 8 may identify, for example, the order in which the referenced content items are to be retrieved, streamed, played back, etc. For example, the entries Sequence 1, Sequence 2, and Sequence 3 may identify the content associated with SeqRef1 LCID, SeqRef3 LCID, and SeqRef2 LCID, as the first, second, and third content item, respectively, in the sequence of content items. The sequence of content may for example include a sequence of home videos, or a sequence of recorded programs intermixed with various advertisements.

In certain variations, further entries in record 8 may determine the timing of the sequence of content items. For example, the entries Seq 1 Duration, Seq 2 Duration, and Seq 3 Duration may indicate a playback time for the first, second, and third content items in the sequence. In this example, the content item associated with the LCID sys1.com/0102030999 will be played back first for 1 hour, 22 minutes, 34 seconds, followed by the content item associated with the LCID sys1.com/0102030997 for 10 minutes, followed by the content item associated with the LCID sys1.com/0102030998 for 30 minutes and 10 seconds. In other variations, other metadata may be specified to indicate timing, such as absolute start and stop times for each content item. Other variations may include no timing data, and instead use timing data in the other referenced records. Some variations may not include entries indicating the sequence of content items, but may infer the sequence by the order of the entries referring to the content items.

Various embodiments may include derived content identifiers (CIDs) and/or assigned CIDs. Assigned CIDs are those CIDs that are assigned to each content object record by CNCD 106, or other subsystem as described above. As previously discussed, assigned CIDs may occur, in various examples, where the pool of available content objects is known to the CNCD 106, and the list of available objects is published for selection by the devices 105.

Derived CIDs include deterministic names that may be generated by the CNCD 106, device 105, or other device based on commonly available metadata. In various examples, each subsystem may generate the same derived CID from the same algorithm using the commonly available metadata as input to the algorithm. With derived CIDs, communication between subsystems may be minimized in that one or more subsystems may be able to derive the name of a content object rather than querying the CNCD 106 for the content object name.

Derived CIDs may be useful, for example, in a data network 100 that includes a local or network DVR service, where the set of content objects to be recorded is determined based on requests from the devices 105. In the local and network DVR example, and in other variations, content objects may be selected at the user device, based on information (e.g., metadata) available in an electronic program guide, or other source of content object metadata that is available to multiple subsystems in data network 100. Such a source, for example, may include a linear program guide available from a server (e.g., third party computing device (e.g., server) 107, that lists a schedule of programs broadcast across multiple sources (e.g., cable channels), at scheduled times, in one or more broadcast regions. In such examples, the derived CIDs may be based on the metadata in the electronic program guide.

Record 9 in FIG. 4B illustrates another variation of a record, that includes a derived CID, labeled DCID. In certain variations, the LCID, Source CID, or other names for the content object in one or more of the namespaces may be derived in the same manner as the DCID. In various examples, the Derived CID may be in the form of a provider ID and asset ID (PAID) identifier that is determined from the metadata identifying the content object in a linear program guide.

As shown in record 9, various examples of the DCID may include a portion derived from an algorithm (e.g., AGEZ0595967209325440), while other portions may be assigned (e.g., sys1.com). The assigned portion, for example, may be a fixed value assigned to all content objects within a pool of content objects.

The DCID of each content object may be a concatenation, in various examples, of a combination of a Source ID (e.g., 2 bytes), Program ID (e.g., 3 bytes), and Scheduled Start Time (e.g., 3 bytes) metadata of a linear program identified in the program guide. In one example, the DCID may begin with a hexavigesimal value of a source ID (e.g., 4 digits) of the content object, right justified, with leading values filled with “A”s. A hexavigesimal number has a base 26, and is represented by the characters A-Z, where 0=A, 1=B, . . . 25=Z. Thus, the hexavigesimal range AAAA-DSYP is equivalent to the decimal range 0-65535.

The source ID, in certain variations, may be concatenated with a decimal representation of the program ID (e.g., 8 digits), right-justified, with leading values filled with zeros. The Program Id, for example, may be a TV Guide® defined unique program identifier.

Following the program ID, the DCID in some examples may include a decimal representation of the Scheduled Start Time (e.g., 8 digits), right justified with leading values filled with zeros. In some examples, time may be represented as minutes since Jan. 1, 1990, GMT.

Using the format above, for example, an 8:00 pm Sep. 24, 2014 EDT showing of “Law and Order” (e.g., program ID 5959672) on TNT (e.g., source ID 418510) a DCID in a PAID format may be derived as follows.

$$\begin{matrix}Source ID = 418510 = ( {0}^{*} 263 + {6}^{*} 261 + {25}^{*} 260 ) = AGEZ 26. & ( 1 ) \\ Program ID = 059599672 & ( 2 ) \\ Start Time ( min . ) = 12 \text{:} 00 AM GMT Jan .1 \; 1990 to \\ 08 \text{:} 00 PM EDT Sept 24 \text{,} 2014 = 13007520 & ( 3 ) \\ \begin{matrix}DCID = Source ID \text{:} Program ID \text{:} Start Time \\ = AGEZ 0595967213007520\end{matrix} & ( 4 )\end{matrix}$$

In certain variations, the derived CID identifies the content object (e.g., video program), but does not identify other information about the content object required to determine the correct content object to deliver to, for example, a device 105. For example, a particular device may require the content object in a certain format (e.g., VBR MPEG). In various examples, when a subsystem (e.g., device 105) communicates to another subsystem (e.g., computing device 104) to identify a content object, the communicating subsystem may send additional metadata with additional requirements.

For example, a device 105 may request a content object to be deliver, recorded, etc. by sending the derived CID for the content object along with additional metadata identifying the required content object format (e.g., VBR MPEG). The receiving device may then query the CNCD for a record of a content object that may include both the derived CID and the required format. For example, a device 105 may request a certain content object having a DCID of AGEZ0595967213007520 and indicate that a required format is VBR MPEG. In response to a query with this information, the CNCD 106 may prepare a response that includes record 10 in FIG. 4C that may include matching entries to the query information. CNCD 106 may then return the response to the requesting device. Alternatively, in another example, a device 105 may request a certain content object having the same DCID, but indicate that a required format is CBR H264. In response, the CNCD 106 may return record 11 in FIG. 4C. In other variations, CNCD 106 may include a single record, such as record 12 in FIG. 4C, having the matching DCID, with alternate listed content objects of different formats.

The records illustrated in FIG. 4A-4C, provide illustrative embodiments having a flat or horizontal name space such as those in records 1-5 and 9-11, where content or data is referred to directly. Other records, such as those illustrated in records 6-8 and 12 may have a vertical or hierarchical structure, where records refer to other records in a hierarchy. To retrieve content or schedule delivery of content, the data network 100 may traverse the hierarchy to reach the correct content file. Each level of the hierarchy may have associated therewith, a different set of metadata.

For example, as discussed above with respect to record 12, a device 105 may request a content item based on a derived content ID (DCID), and the request may specifically include metadata that requests a CBR H264 format. Record 12 may represent a first layer of a hierarchy. Parsing record 12 by the device 105, CNCD 106, or other device in system 100 may determine from “Altref2 Format=CBR H624” that the requested content is identified by “AltRef2 LCID=sys1.com/8882030405,” which refers to record 8. Record 8 may represent a second layer of the hierarchy, which may include its own metadata, such as sequence duration information. Record 8 may refer to one or more common content object files (e.g., SeqRef1 LCID, SeqRef3 LCID, and SeqRef2 LCID), which represent a third layer of hierarchy. Because of the flexible nature of the records referring to other records, horizontal and vertical hierarchies may be intermixed within data network 100, the hierarchies may be defined by the metadata inserted in the records, and different levels of a hierarchy may be modified by updating the records, without modifying other levels of the hierarchy.

In certain embodiments, LCIDs or content identifiers (CIDs) in other namespaces (e.g., CDN CID, Source CID, etc.), may be de-allocated or reallocated from one content object to a different content object. For example, in some embodiments, the recorded content object (e.g., video program) may be available to the device 105 for a predetermined fixed period of time. In other variations, a content object record may be deleted or overwritten based on a request from the device 105 (e.g., to make room for new recorded programs). Once the recorded program is no longer available to the user device, the CNCD 106 may delete the content object record to make the assigned LCID available for another content object when a new content object is added to the pool of content objects.

In another example, a content identifier in another namespace may be reallocated. For example, if the CDN 103 namespace is limited, CDN CIDs in the records may be reallocated based on what content files are currently being delivered or scheduled to be delivered through the CDN 103. This may occur as, for example, requests for content are received, or playback is scheduled, to dynamically assign a CDN CID to a content record as needed. The CDN CID, or other name in another namespace, may be re-used among the several records based on changing requirements for delivery, ingest, or storage.

In various examples, the CNCD 106 may dynamically allocate and reallocate available content identifiers to accommodate a larger number of content objects that can be handled by data network 100. In one example, the CNCD 106 may dynamically allocate and reallocate available CIDs to different content sources and storage devices. In some variations, the allocation of a CID may persist for a fixed duration sufficient to deliver the content object to a user device (e.g., for the duration of a user's request to deliver/view/use that content). The fixed duration may be a metadata value stored in the record for the content object. After the fixed duration of a content request has expired, the CNCD 106, in some cases, may reclaim or disassociate an allocated CID for use in a future content object request. In such a case, a single CID may be used to refer to different content objects at different times.

FIG. 5 illustrates one example in which reallocation of CIDs (e.g., LCID, CDN CID, Source CID, Storage CID, etc.) may occur. In various embodiments, for example, reallocation may occur in a data network 100, such as e.g., in a network digital video recorder system (nDVR), video on demand system or other multimedia delivery system. In such an example, at step 502 one or more devices (e.g., devices) 105 may select a video program or other content object for recording. The video program may be selected, for example, by a user of the device 105 from an electronic program guide. Once selected, metadata identifying the program (e.g., DCID, program name, channel, broadcast time, duration, format, etc.) may be sent in step 504 to a scheduler in the computing device 104 for requesting that the selected program be recorded. In step 506, the LCID, or content identifier in another namespace, of the requested program may be determined through one or more queries to a CNCD 106 using the provided metadata. The content object record in the CNCD 106 for the requested program may be determined in step 507 (e.g., retrieved from a memory), and/or optionally created in step 508 at various times during this process (e.g., when selected by the user at the device 105, when queried by the scheduler, etc.). In some variations, step 508 may include reassigning a CID (e.g., LCID) from an unused record to the record for the newly requested content object. The scheduler, based on the CID and other provided metadata creates in step 510 a recording (e.g., an nDVR, local DVR) schedule record, which is a record that identifies a program to be recorded. Based on the schedule record, storage 102 (or a second user device, local DVR, etc.) is configured in step 512 to record the content object at the start time in a format decodable by the requesting device 105 or other designated device. In various examples, storage 102 may be another device 105, such as a local DVR that is different from the requesting device 105. In various examples, a content identifier associated with the content object in the storage namespace may be created or reassigned from a previously used storage content identifier.

The recorded program may then, in step 514, be provided to the requesting device 105 or other designated device via the CDN 103 at a time indicated in the schedule record, or at a later time requested by the requesting device 105 (e.g., on demand). In delivering the content object, a content identifier associated with the CDN 103 may be created or reassigned from a previously used CDN content identifier. The creating of each content identifier for each name space (e.g., CDN CID, storage CID, etc.) may be created or reassigned at different times in the process. For example, every namespace CID required to record and deliver the content to the device 105 may be created at the time of the original request in step 504, or may be created at the time needed (e.g., at the time of ingest, storage, delivery, etc.).

The timing of dynamically allocating/reallocating content identifiers in the different name spaces may be such that, as content is being recorded/ingested, it is available immediately or available after a delay sufficient to allow the storing and retrieval of a portion of the content already recorded, before recording is completed. For example, the processes 200 and 500 may be performed simultaneously and in conjunctions so that, just after recording begins playback can begin even though the entire content object is not yet stored.

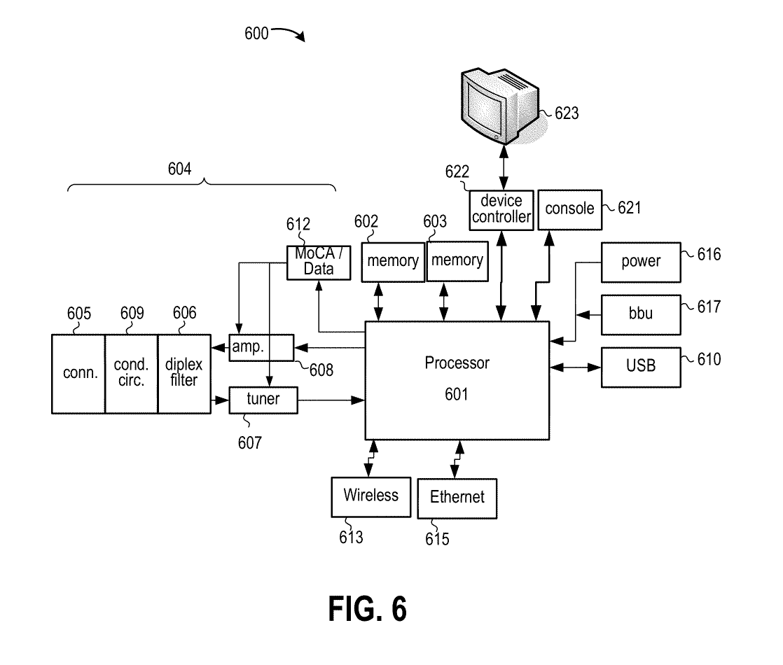

FIG. 6 is a block diagram of equipment 600 in which the various disclosed transmitter devices, receiver devices, network components, servers, and other described embodiments may be implemented. For example, content sources 101, storage 102, CDN 103, computing device (e.g., central server) 104, devices 105, content name computing device 106 and third party service computing device 107, may each include various portions of equipment 600 for transmitting, receiving, processing, and displaying data.

A main processor 601 is configured to execute instructions, and to control operation of other components of equipment 600. Processor 601 may be implemented with any of numerous types of devices, including but not limited to, one or more general-purpose microprocessors, one or more application specific integrated circuits, one or more field programmable gate arrays, and combinations thereof. In at least some embodiments, processor 601 carries out operations described herein according to machine-readable instructions (e.g. software, firmware, etc.) stored in memory 602 and 603 and/or stored as hardwired logic gates within processor 601. Processor 601 may communicate with and control memory 602 and 603 and other components within 600 over one or more buses. Memory 602 and 603 may further store data and/or metadata, such as content objects, content object records, DVR schedule records, etc., organized and encoded in various formats as described herein.

Main processor 601 may communicate with networks (e.g., networks between the subsystems of data network 100) or other devices across one or more RF, microwave, and or optical interfaces 604 that may include a cable connector (or other type of connector) 605, a signal conditioning circuit 609 (e.g., filter, amplifier, etc.), a diplex filter 606, a tuner 607 (e.g., wideband, narrowband, television, FM, QPSK, QAM, etc.), upstream communication amplifier 608, and one or more standard specific interfaces 612 (e.g., a MOCA® interface, a DOCSIS® interface, etc.). Main processor 601 may also communicate with other devices through additional interfaces, such as a USB interface 610, Ethernet interface 615, wireless interfaces 613 (e.g., Bluetooth, 802.11, etc.), etc. A power supply 616 and/or battery backup 617 may provide electrical power. User input to equipment 600 may be provided over one of the aforementioned interfaces (e.g., 604, 610, 613, 615, etc.), or via a separate collection of buttons, infrared ports, or other controls in a console 621. Equipment 600 may include one or more output devices, such as a display 623 (or an external monitor, television, etc.), and may include one or more output device controllers 622, such as a video processor.

Memory 602 and 603 may include volatile and non-volatile memory and can include any of various types of tangible machine-readable storage medium, including one or more of the following types of storage devices: read only memory (ROM) modules, random access memory (RAM) modules, magnetic tape, magnetic discs (e.g., a fixed hard disk drive or a removable floppy disk), optical disk (e.g., a CD-ROM disc, a CD-RW disc, a DVD disc), flash memory, and EEPROM memory. As used herein (including the claims), a tangible machine-readable storage medium is a physical structure that can be touched by a human. A signal would not by itself constitute a tangible machine-readable storage medium, although other embodiments may include signals or other ephemeral versions of data, metadata, and instructions executable by one or more processors to carry out one or more of the operations described herein.

In at least some embodiments, each of the subsystems of data network 100, and other equipment, which perform the various described processes, may be implemented as a single computing platform or multiple computing platforms, such as multiple equipment 600, for redundancy and/or to increase the amount of analysis, data storage and other operations being performed simultaneously, or for convenience. Additionally, in various embodiments, multiple computing platforms may be configured to communicate over one or more networks to perform the various described processes of any single or multiple servers, user equipment or other equipment described above (e.g., cloud computing).

In the various illustrative embodiments described above, the communications between the subsystems may be accomplished through a group of networks, which are represented by the arrowed lines between each of the subsystems. The networks may include a single network or combination of networks, including one or more private or public, local or wide area, networks and in-home networks, which may be wired and/or wireless. These may include, for example, coaxial, fiber, or hybrid fiber/coaxial distribution systems (e.g., a DOCSIS network), digital subscriber line (DSL) networks, a satellite communication networks, wireless and cellular networks, and/or a PBX networks, and combinations thereof. The networks may also include various routers, gateways, servers, antennas, repeaters, satellites, etc., for receiving and transmitting data through the network.

The networks may include a wide area wireless network providing mobile telephony and other types of mobile services to mobile user equipment, such as mobile telephones, “smart” phones, personal digital assistants (PDAs), laptops, electronic book readers, tablets, touchpad devices, and other types of wireless handheld devices. Examples of such wide area wireless networks include but are not limited to satellite and cellular telephone networks, 2G, 3G, 4G, etc. mobile networks and telecommunication networks, including CDMA, WCDMA, GSM, CDMA2000, TD-SCDMA, WiMAX, LTE solutions, EDGE (Enhanced Data rate for GSM Evolution) networks, EVDO (EVolution Data Optimized) networks, etc. The networks may further include, but are not limited to, such technologies as Bluetooth networks, femtocell technology, Digital Enhanced Cordless Telephone (DECT) networks, WiFi networks according to IEEE 602.11, Cordless Advanced Technology-Internet and Quality (CAT-iq) networks, Ethernet networks Multimedia Over Coax Alliance (MOCA) networks, Digital Living Network Alliance (DLNA) networks, etc.

The networks may include a central network through which all devices communicate, and/or may comprise a number of separate networks, where only certain devices communicate with one another through a first network, while other devices communicate through a different network not connected to the first network.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and their practical application to enable one skilled in the art to utilize the present invention in various embodiments and with various modifications as are suited to the particular use contemplated. All embodiments need not necessarily achieve all objects or advantages identified above. All permutations of features from the above-described embodiments are within the scope of the invention.

1. An apparatus comprising:
one or more processors; and
one or more memories storing machine executable instructions, that when executed by the one or more processors, cause the system to:
create an association between a first content object and a plurality of names from a plurality of different namespaces, respectively;
receive a query including metadata associated with the first content object; and
transmit a response including one of the plurality of names in response to the query.

2. The apparatus of claim 1, wherein the instructions, when executed by the processor, cause the apparatus to:
disassociate a first name of the plurality of names with a second content object before creating the association of the first name with the first content object.

3. The apparatus of claim 1, wherein at least one of the plurality of names is a derived name based on metadata available from an electronic program guide.

4. The apparatus of claim 1, wherein the association between the first content object and the plurality of names from the plurality of different namespaces is maintained in a record, the record further including metadata identifying a first user device associated with the first content object.

5. The apparatus of claim 4, wherein the association between the first content object and the plurality of names from the plurality of different namespaces is maintained in a record, at least one of the plurality of names referring to a second record associated with a copy of the first content object available to multiple user devices.

6. The apparatus of claim 1, wherein each namespace in the plurality of different namespaces is associated with a respective subsystem in a plurality of subsystems of a data delivery system.

7. The apparatus of claim 6, wherein the system includes a network digital video recorder system, and wherein the first content object is a video program scheduled for recording for a user device communicatively coupled to the data delivery system.

8. The apparatus of claim 6, wherein the instructions, when executed by the processor, cause the apparatus to:
receive a request from a user device to deliver the first content object through the data delivery system;
configure one or more of the subsystems to deliver the first content object to the user device, wherein first content object is identified to each of the one or more subsystems by the name in the namespace associated with that subsystem.

9. The apparatus of claim 6, wherein at least one of the plurality of names includes data to resolve a location of the respective subsystem of the respective namespace.

10. A method comprising:
storing in a memory an association between a first content object and a plurality of names from a plurality of different namespaces, respectively, each namespace in the plurality of different namespaces associated with a respective portion of a plurality of different portions of a data network;
receiving a query comprising metadata associated with the first content object; and
preparing a response including one of the plurality of names in response to the query.

11. The method of claim 10, further comprising:
removing from the memory an association of a first name of the plurality of names with a second content object; and
storing in the memory the association of the first name with the first content object.

12. The method of claim 10, wherein at least one of the plurality of names is a derived name based on metadata available from an electronic program guide.

13. The method of claim 10, wherein the association between the first content object and the plurality of names from the plurality of different namespaces is maintained in a record stored in the memory, the record further including metadata identifying a first user device associated with the first content object.

14. The method of claim 10, wherein the association between the first content object and the plurality of names from the plurality of different namespaces is maintained in a record stored in the memory, at least one of the names referring to a second record associated with a copy of the first content object that is available to multiple user devices.

15. The method of claim 10, wherein each portion of the plurality of portions of the data network include a subsystem of a plurality of subsystems of a data delivery system.

16. The method of claim 15, wherein the data delivery system includes a network digital video recorder system, and wherein the first content object is a video program scheduled for recording for a user device communicatively coupled to the data delivery system.

17. The method of claim 15, further comprising:
receiving a request from a user device to deliver the first content object through the data delivery system;
resolving a location of each subsystem from an identifier in the name of the respective namespace associated with the subsystem, respectively; and
configuring one or more of the subsystems to deliver the first content object to the user device, wherein the first content object is identified to each of the one or more subsystems by the name in the namespace associated with that subsystem.

18. A non-transitory computer readable memory storing machine executable instructions, that when executed by one or more processors, cause a device to:
create an association between a first content object and a plurality of names from a plurality of different namespaces, respectively;
receive a query including metadata associated with the first content object; and
transmit a response including one of the plurality of names in response to the query.

19. The non-transitory computer readable memory of claim 18, wherein the instructions, when executed by the processor, cause the device to:
disassociate a first name of the plurality of names with a second content object before creating the association of the first name with the first content object.

20. The non-transitory computer readable memory of claim 18, wherein at least one of the plurality of names is a derived name based on metadata available from an electronic program guide.
